(19) United States
(12) Patent Application Publication
(10) Pub. No.: US 2005/0175156 A1
(43) Pub. Date: Aug. 11, 2005

(54) Calea in a VPN environment (formerly called restricted anti-calea

(76) Inventors: Siroos K. Afshar, Manalapan, NJ (US); Alireza Faryar, Fair Haven, NJ (US); Mark J. Foladare, Middlesex, NJ (US); Radhika R. Roy, Howell, NJ (US); Larry Russell, Atlantic Highlands, NJ (US)

Correspondence Address: AT&T CORP., P.O. BOX 4110, MIDDLETOWN, NJ, 07748, US

(21) Appl. No.: 10/773,639

(22) Filed: Feb. 5, 2004

(51) Int. Cl. H04M 3/08; H04M 1/24

(52) U.S. Cl. 379/35

(57) ABSTRACT

Method and system are disclosed for intercepting voice/multimedia calls in a VPN environment. The calls are diverted to a voice/multimedia call intercepting server where the intercept subject is identified. The identification may be based on an image/picture as well as identifying information about the intercept subject provided to the VPN administrator. The identifying information may be, for example, a telephone number, URL, name, and the like, for the intercept subject. The combination of image/picture and identifying information is especially useful to confirm telephone numbers, URLs, names, and the like that can be used by someone other than real intercept subject. Once the identity of the intercept subject is confirmed, the call content is duplicated, encapsulated, and/or transported to the law enforcement agency. The method and system of the invention then re originates the call to prevent the intercept subject from detecting the intercept.

### FIELD OF THE INVENTION

This invention relates to the field of telecommunication and, in particular, to a system and method for intercepting voice/multimedia calls in a virtual private network (VPN).

### BACKGROUND OF THE INVENTION

A VPN, as the name implies, is a private network that is established over an otherwise public network, such as the Internet. Typically used in a corporate environment, the VPN can provide secure and reliable transfer of text, voice, image, and video data between locally and remotely located offices without the use of expensive, dedicated data lines. Instead, the VPN uses a combination of encryption and user authentication along with other security mechanisms to maintain the security of the communication. For more information regarding VPNs, the reader is directed to, for example, I. Pepelnjak and J. Guichard, “MPLS and VPN Architectures,” Cisco Press, 2001.

With the security of a VPN, however, a number of issues may arise. In particular, recent advances in telecommunication technology have made Internet telephony and video conferencing a practical alternative to traditional solutions. Implementing these services over a VPN instead of the Internet provides a reliable and secure way for users to place voice and/or multimedia calls to one another, but makes the transparent monitoring and interception of such calls more problematic. In other words, the VPN is so secure as to prevent law enforcement agencies (LEA) from carrying out legal law enforcement activities, such as intercepting and monitoring the voice and/or multimedia calls of suspected criminals.

Traditionally, intercepting a communication was performed by wiretapping. That is, a law enforcement agency would physically tap into an intercept subject's telephone lines and monitor his communication. Since the communication was transmitted as unencrypted analog signals, any suitable listening device, such as an ordinary telephone, could be used to listen in on the call.

In a VPN, however, the voice and/or multimedia calls are transmitted as highly encrypted data packets. Thus, the law enforcement agency would not be able to understand the communication even if it somehow managed to tap into the intercept subject's line. In addition, the data packets are routed through the VPN on a hop-by-hop basis and not along any specific path (i.e., “connectionless”), which makes it difficult to capture every single data packet. Moreover, any attempt to divert the data packets (e.g., through a law enforcement agency server) may be detected by tracing the route followed by the data packets.

Accordingly, what is needed is a way to allow law enforcement agencies to intercept Internet based voice and/or multimedia calls in a VPN. In particular, what is a needed is a way to allow the law enforcement agencies to intercept the Internet based voice and/or multimedia calls without alerting the intercept subject to the law enforcement activity.

### SUMMARY OF THE INVENTION

The present invention is directed to a method and system for intercepting voice/multimedia calls in a VPN environment. The calls are diverted to a voice/multimedia call intercepting server where the intercept subject is identified. The identification may be based on an image/picture as well as identifying information about the intercept subject provided to the VPN administrator. The identifying information may be, for example, a telephone number, URL, name, and the like, for the intercept subject. The combination of image/picture and identifying information is especially useful to confirm telephone numbers, URLs, names, and the like that can be used by someone other than real intercept subject. Once the identity of the intercept subject is confirmed, the call content is duplicated, encapsulated, and/or transported to the law enforcement agency. The method and system of the invention then re-originates the call to prevent the intercept subject from detecting the intercept.

In general, in one aspect, the invention is directed to a method of intercepting a voice/multimedia call in a VPN. The method comprises setting up the voice/multimedia call in the VPN, the call composed of a plurality of data packets and signaling information. The method further comprises extracting an identifying information for the voice/multimedia call from the signaling information. A determination is made as to whether at least one participant in the voice/multimedia call matches the intercept subject. If there is a match, then the plurality of data packets and the signaling information is duplicated. The plurality of data packets and the signaling information are thereafter re-originated in the VPN.

In general, in another aspect, the invention is directed to a VPN that is capable of intercepting a voice/multimedia call composed of a plurality of data packets and signaling information being routed therethrough. The VPN comprises a call control entity configured to set up the voice/multimedia call in the VPN and to extract an identifying information from the signaling information. The VPN further comprises a call intercepting server configured to determine whether at least one participant in the voice/multimedia call matches an intercept subject. The plurality of data packets and the signaling information are duplicated if there is a match. The call control entity is further configured to re-originate the plurality of data packets and the signaling information in the VPN.

### BRIEF DESCRIPTION OF THE DRAWINGS

The foregoing and other advantages of the invention will become apparent from the following detailed description and upon reference to the drawings, wherein:

FIG. 1 illustrates an architecture for a conventional voice/multimedia corporate VPN;

FIG. 2 illustrates an architecture for a voice/multimedia VPN with call intercept capability according to embodiments of the invention;

FIG. 3 illustrates a method of intercepting a call in a voice/multimedia VPN according to embodiments of the invention; and

FIG. 4 illustrates a method of determining whether a call contains an intercept subject according to embodiments of the invention.

### DESCRIPTION OF ILLUSTRATIVE EMBODIMENTS

Following is a detailed description of illustrative embodiments of the invention with reference to the drawings wherein the same reference labels are used for the same or similar elements.

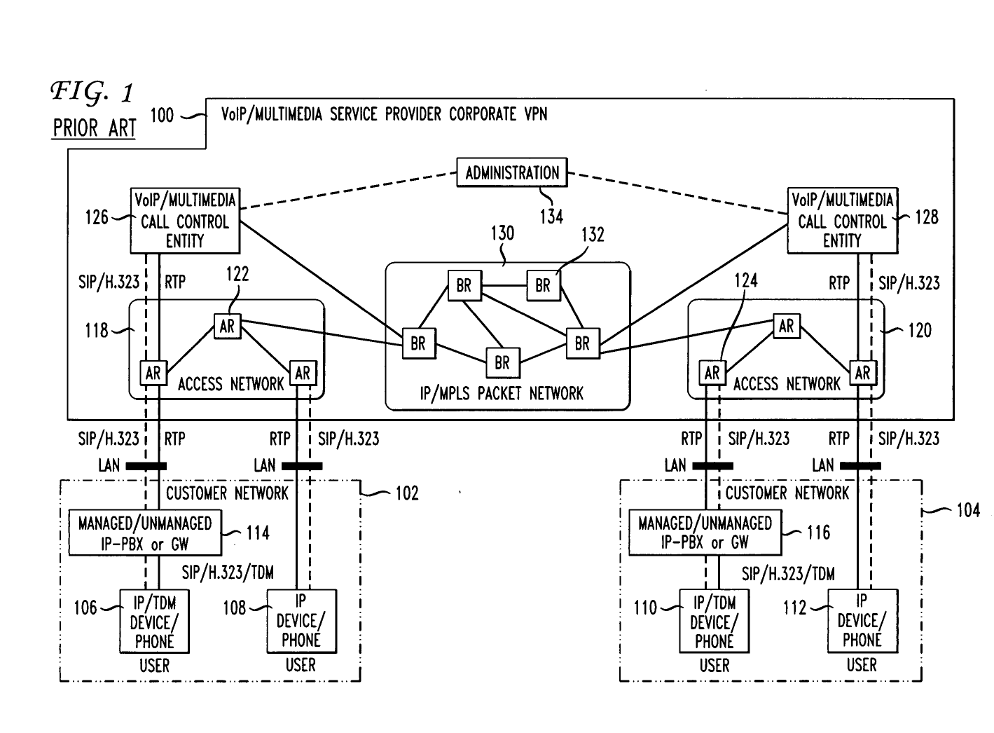

FIG. 1 illustrates an example of an existing voice/multimedia corporate VPN 100 available as a service from VPN service providers such as the AT&T Corporation. The voice/multimedia corporate VPN 100 is well-known to persons having ordinary skill in the art and will therefore be described only generally here. The VPN 100 allows a customer's locally and remotely located offices to be connected together. Specifically, the VPN 100 facilitates secure and reliable transfers of voice/multimedia data between the customer's local area networks, two of which are shown at 102 and 104. The local area networks 102 and 104 include a plurality of corporate users 106-112 connected thereto. The users 106-112 can access the local area networks 102 and 104 using any suitable communication device, such as an IP telephone, TDM (time division multiple access) device, FDM (frequency division multiple access) device, computer, personal digital assistant (PDA), and the like (hereinafter “multimedia device”).

When a voice/multimedia call is originated by a user 106-112, the multimedia device of the user 106-112 converts the call into data packets of different media types (e.g., audio, video) that contain the voice/images/video of the call (represented by solid lines with no arrowheads). The multimedia device also generates signaling information (represented by broken lines with no arrowheads) for the voice/multimedia call, usually referred to as out-of-band signaling. The signaling information may be implemented using any suitable signaling protocol, such as the Sessions Initiation Protocol (SIP) and H.323. Similarly, the data packets may be implemented using any suitable protocol, such as the Real-time Transport Protocol (RTP). These protocols are well-known to persons having ordinary skill in the art and will not be discussed here. Additionally, although FIG. 1 specifically references the Voice Over IP (VoIP) protocol, the call control entities 126 and a 28 may use any suitable IP telephony or multimedia standard.

The data packets of different media types and the signaling information are then routed through a managed or unmanaged IP-based public branch exchange (IP-PBX) or gateway, indicated at 114 and 116, to the local area networks 102 and 104. It is of course possible for the multimedia devices to be directly connected to the local area networks 102 and 104, in which case there is no need to route the call through an IP-PBX. In any case, the local area networks 102 and 104 forward the data packets and signaling information to one of the access networks, two of which are indicated at 118 and 120. Within the access networks 118 and 120 are a plurality of access routers, two of which are labeled at 122 and 124. These access routers 122 and 124 forward the data packets and the signaling information to a respective one of the voice/multimedia call control entities 126 and 128.

The voice/multimedia call control entities 126 and 128 are responsible for setting up the call and routing the data packets over the VPN 100 using the addresses contained in signaling information. Upon receiving the data packets, the voice/multimedia call control entities 126 and 128 determine the appropriate destination for the data packets based on the addresses contained in the signaling information. The voice/multimedia call control entities 126 and 128 thereafter forward the data packets to a backbone network 130.

The backbone network 130, which may be an IP and/or multi-protocol label switching (MPLS) backbone network, includes a plurality of backbone routers, one of which is indicated at 132. The specific backbone router 132 to which the data packets are forwarded usually depends on the destination address specified in the signaling information. In any event, after the data packets are routed by the backbone routers 132 through the backbone network 130, they are forwarded to the access network 118 or 120 and the local area network 102 or 104 of the called user 106-112.

To take an example of a call flow according to the above VPN architecture, a typical call would be routed from the originating user 108 in the local area network 102 to the access network 118, then to the voice/multimedia call control entity 126, then to the backbone network 130, then to the access network 120, and finally to the destination user 112 in the local area network 104. The above arrangement is often referred to as “connectionless” due to the lack of a specific path or set of routers through the VPN 100 on which the data packets are routed.

As explained above, however, the “connectionless” nature of existing voice/multimedia VPN architectures can make it very difficult for law enforcement agencies to intercept a voice/multimedia call. This is due not only to the fact that the data packets are encrypted, but also because the route taken by the data packets is traceable in most cases. Therefore, the inventors of the present invention have created a new voice/multimedia VPN architecture that lets law enforcement agencies intercept a voice/multimedia call, and lets them do it without alerting the intercept subject.

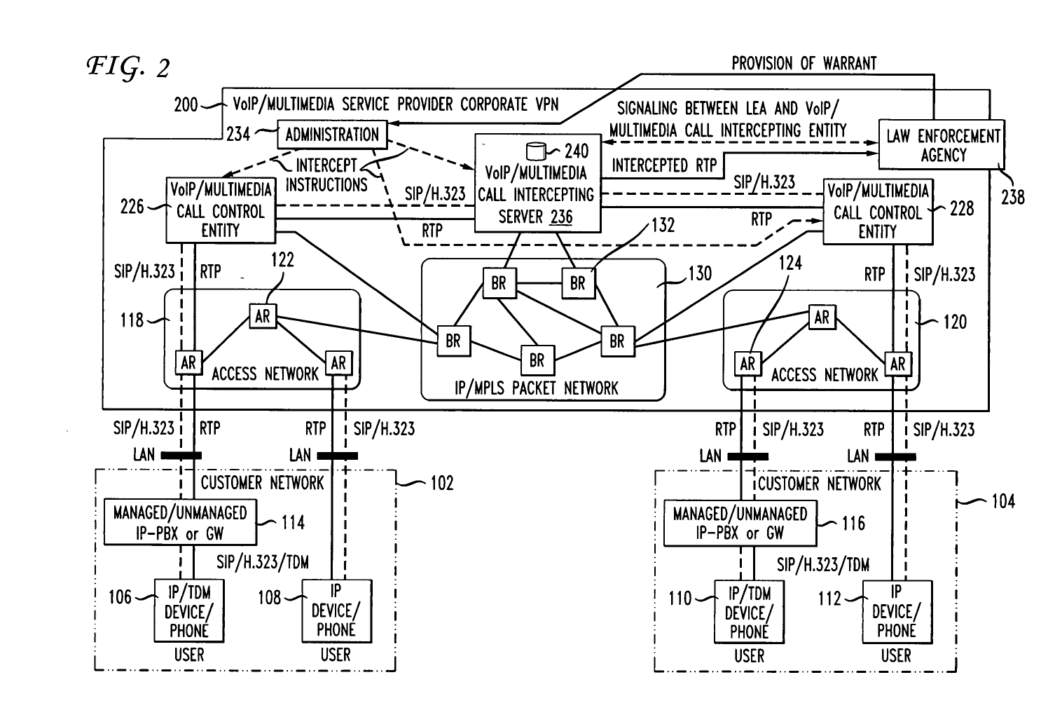

Referring now to FIG. 2, a voice/multimedia VPN 200 according to embodiments of the invention is shown. The VPN 200 is otherwise similar to the VPN 100 of FIG. 1 except that the voice/multimedia call control entities (now labeled 226 and 228) and the VPN administrator (now labeled 234) have been configured to facilitate or help carry out call intercept activities. This additional functionality may be added to the VPN 200 either as software in some embodiments, or it may be implemented as hardware in other embodiments, or a combination of both. In addition, the voice/multimedia VPN 200 further includes a voice/multimedia call intercepting server 236 that has been configured to intercept voice/multimedia calls and to forward the calls to a law-enforcement agency 238. The operation of the voice/multimedia VPN 200 will now be described.

To initiate the interception of a call, the law-enforcement agency 238 must provide legal authorization (e.g., warrants, court orders, etc.) to the VPN administrator 234 of the voice/multimedia VPN service provider. Once this is done, the VPN administrator 234 of the service provider can instruct the voice/multimedia call control entities 226 and 228 to keep track of the network activities of the intercept subject. If the call control entities 226 and 228 detect that the intercept subject has made a call, they request the voice/multimedia call intercepting server 236 to record the voice/multimedia call signaling information and/or data packets as specified by the law enforcement agency's legal authorization. The voice/multimedia call intercepting server 236 then duplicates the data packets and/or signaling information of the voice/multimedia call from the intercept subject in a manner that is substantially transparent so that the intercept subject does not detect the interception.

In some embodiments, the voice/multimedia call intercepting server 236 is a logical entity, the physical realization of which can be done in many ways. For example, the voice/multimedia call intercepting server 236 can be located as a physical part of any call control entity 226 and 228, or it can be a separate stand-alone entity shared by many call control entities, such as the case shown here. If the voice/multimedia call intercepting server 236 is a physical part of the call control entity 226 and 228, it may do the intercepting, replicating, encapsulating and transporting of the data packets to the law enforcement agency 238 while running in the background. If the voice/multimedia call intercepting server 236 is a separate physical entity, the call control entities 226 and 228 may use any suitable voice/multimedia call control protocol (e.g., SIP, H.323) to transport the signaling information and/or data packets to the voice/multimedia call intercepting server 236. The call control entities 226 and 228 thereafter re-originate the call to be access network 118 and 120 so that the intercept subject does not directly or indirectly detect the voice/multimedia call intercepting server 236. Such re-originating technology is well within the knowledge and ability of those having ordinary skill in the art and will therefore not be described here.

To take an example of a call flow according to the present invention, an intercepted call goes from the originating user 108 in the local area network 102 to the access network 118, to the call control entity 226, to the backbone network 130, then to the access network 220, and then to the destination user 112 in the local area network 104. In addition, the intercepted call also goes to the voice/multimedia call intercepting server 236 and thereafter to the law enforcement agency 238 as appropriate.

The details of the call flow for the interception can be described as follows. If any user, say user 108, makes any call to any destination, that call is serviced by the VPN service provider using either a public address (e.g., a MAC address, email address, URL, etc.) reserved for the user 108, or using a private address allocated to the user 108 by the VPN service provider. If private, the VPN service administrator 234 translates the private address of the user 108 into an address that may be made public and known outside the VPN if that call needs to go off-net. If the call is on-net (i.e., within the VPN), the address will remain private, known only to the service provider and the user 108, depending on the service level agreement.

The signaling information from the multimedia device of the user 108 is forwarded to the call control entity 226 via the access network 118. The access network 118 merely transports the call signaling information from the user 108 to the call control entity 226 and is not concerned with or aware of the content of the call.

The call signaling information between the multimedia device of the user 108 and the call control entity 226 may be encrypted. If so, the encryption key must be made known to the VPN service administrator 234, since services cannot be provided to the user 108 without knowing the signaling information. The encryption key of the user may be made known to the VPN service administrator 234 using any suitable means (e.g., postal service, personal delivery, by telephone, etc.). The key distribution can also be done dynamically by opening a secured channel between the user 108 and the VPN administrator 234 via the backbone network 130 using any suitable protocol such as IPSec (IP Security) or TLS (Transport Layer Security), a third party key distribution system trusted by both the user 108 and the VPN administrator 234, and the like. The VPN service administrator 234 may then send the encryption key to the law enforcement agency 238, for example, from the voice/multimedia call intercepting server 236. The law enforcement agency 238 then uses the encryption key to decrypt the intercepted signaling information.

When the signaling information arrives at the call control entity 226, the call control entity 226 checks to see whether this call is the call of the intercept subject. If it is, the call control entity 226 forwards the data packets and signaling information to the voice/multimedia call intercepting server 236. The voice/multimedia call intercepting server 236 thereafter replicates, encapsulates, and stores the voice/image/video content of the data packets in a database 240. Encapsulation of the intercepted content may be done using a key provided by the law enforcement agency 238 and affords additional protection so that no unauthorized person (e.g., VPN service provider personnel) can access the intercepted content. In a preferred embodiment, the intercepted data packets are stored in their encapsulated form, including all security and encryption mechanisms. The voice/multimedia call intercepting server 236 will then set up a separate connection in the VPN 200 with the law enforcement agency 238 to transfer the replicated and encapsulated call content to the law enforcement agency 238. This transfer may, but does not have to, take place at the same time as the intercepted call.

In addition to its call interception and recording capabilities, the voice/multimedia call intercepting server 236 also includes a number of other intelligent functions. For example, it is important that only the voice/multimedia calls of the intercept subject be intercepted. Thus, in some embodiments, the voice/multimedia call intercepting server 236 is capable of identifying the intercept subject based on an image, telephone number, URL, name, and/or the like, as provided by the law enforcement agency 238.

The criteria used for intercepting the voice/multimedia calls may come from the law enforcement agency in a variety of ways. For example, in some cases, the law enforcement agency may have only the image of the intercept subject and the call is intercepted based on that image. In that case, the VPN administrator 234 would need to provide the law enforcement agency 238 with any information it has ascertained, such as the telephone number, URL, name, and any other information related to the call signaling information, caller image, or content of the call.

In some cases, the law enforcement agency 238 may have only the caller identification information (e.g., telephone number, URL, name) and the call interception is based on that information. If so, the VPN administrator 234 again needs to provide the law enforcement agency with any information it has ascertained, including the identification information and any other information related to the call signaling information, caller image, or content of the call.

In some cases, the law enforcement agency 238 may have both the image and a caller identification (e.g., telephone number, URL, name) and the interception is based on both items. In that case, the VPN administrator 234 still needs to provide the law enforcement agency 238 with any information it has ascertained, including the identification information and any other information related to the call signaling information, caller image, or content of the call.

Thus, in all situations, all information related to the intercept subject needs to be sent to the law enforcement agency 238. That is, no information related to the intercept subject should be kept by the VPN administrator 234 if the law enforcement agency 238 has requested all call content related to the media of the intercept subject in addition to the signaling information.

Depending on the particular case, the operation of the voice/multimedia call intercepting server 236 and the call control entity 226 or 228 may be different. Where the law enforcement agency 238 provides only the image of the intercept subject, an identification may be difficult until the call is established and the picture/image of the caller or callee is sent by the multimedia device. Thus, at the time of the call setup, it is unlikely to be very clear whether to intercept the call based only on the caller's/callee's identifying information (e.g., telephone number, URL, name). Therefore, in some embodiments, every call or almost every call is routed through the voice/multimedia call intercepting server 236 in order to try and match the image provided by the law enforcement agency with one of the callers or callees.

To assist in matching the image, in some embodiments, the voice/multimedia call intercepting server 236 may be equipped with image recognition capability. This image recognition capability may be used to identify the caller/callee based on slow moving head and/or shoulder shots where available. Such image recognition may take a while if the subject makes low head and shoulder movements and/or the pictures/images are not very clear. Thus, the voice/multimedia call intercepting server 236 may be configured to perform the image recognition only until some predetermined criteria is met if confirmation of the intercept subject is not obtained. For example, the voice/multimedia call intercepting server 236 may be configured to perform the image recognition only for a predefined amount of time, or until a sufficient number of different kinds of pictures/images of the intercept subject has been examined. If the voice/multimedia call intercepting server 236 determines that there is no match based on the predetermined criteria, then it releases the image recognition resources.

When there is no match, the voice/multimedia call intercepting server 236 notifies the call control entity 226 or 228 accordingly. In that case, other steps may need to be taken to identify the intercept subject without using the image recognition resources of the voice/multimedia call intercepting server 236. The call control entities 226 and 228 may then be configured to reestablish the call, but bypassing the voice/multimedia call intercepting server 236.

When a match is found via the image recognition capability of the voice/multimedia call intercepting server 236, the content (e.g., audio, video) of the call is replicated, encapsulated and transported to the law enforcement agency 238. The transport of the intercepted content to the law enforcement agency 238 may be accomplished using an RTP connection, or it may be performed using some other mechanism as specified in the law enforcement agency. In addition to transporting the call content, the voice/multimedia call intercepting server 236 may also transport information related to the intercept subject's identifying information (e.g., telephone number, URL, name) using, for example, the SIP/H.323 signaling channel.

Preferably, the above intercepting functions are done in a substantially transparent manner such that the intercept subject is not able to detect the interception either directly or by indirect means. For example, if the intercept subject uses IP trace route messages to trace the source-destination IP path of the data packets, the call control entities 226 and 228 may be configured to block the IP trace route messages as part of the process of re-originating the data packets from the caller and the callee.

An advantage of the invention as described above is that it improves the ability of law enforcement agencies to carry out their enforcement activities. Oftentimes, law enforcement agencies have very little information about a suspect except for a picture or an image obtained from cameras or from a witness' recollection of the suspect. In such cases, the image recognition capability present in some embodiments of the invention lets law enforcement agencies monitor/intercept calls based only on the picture/image of the subject. On the other hand, if there is no match for the image, the invention is configured to release the image recognition function in order to conserve resources.

For the second case where the law enforcement agency 238 provides only the identifying information of the subject (e.g., telephone number, URL, name) and not the image, the call control entities 226 and 228 are configured to determine whether the signaling information received at the time of the call setup corresponds to the identifying information provided. If it does, the call control entities 226 and 228 forward data packets and the signaling information to the voice/multimedia call intercepting server 236 and request that it intercept the call. The voice/multimedia call intercepting server 236 thereafter replicates and encapsulates the call content (e.g., audio, video) and transports the content to the law enforcement agency 238 over the RTP connection, or as otherwise specified by the law enforcement agency 238. In addition to the call content, the voice/multimedia call intercepting server 236 may also transport information related to the intercept subject's identifying information (e.g., telephone number, URL, name) to the law enforcement agency 238 using the SIP/H.323 connection. The intercepting functions are again preferably done transparently such that the intercept subject is unable to detect the interception either directly or indirectly. For example, as before, if the intercept subject uses IP trace route messages to determine the source-destination IP path of the data packets, the call control entities 226 and 228 are configured to block those IP trace route messages as part of the process of re-originating the data packets from the caller and the callee.

Here, the voice/multimedia call intercepting server 236 does not need to perform image recognition of the images received from the call control entities 226 and 228, since it is assumed that the identifying information of the suspect as provided by the law enforcement agency 238 is correct. Still, an advantage of this approach is that the law enforcement agency 238 can confirm whether the identifying information it provided is the correct one for the intercept subject based on the intercepted images/pictures. This capability is useful where the multimedia device that is being intercepted may be used by someone other than the intercept subject.

For the third case where the law enforcement agency 238 provides both the image and the identifying information (e.g., telephone number, URL, name) of the intercept subject, it is assumed that image of the intercept subject and identifying information of the intercept subject correspond. Call interception in this case may be simpler because the voice/multimedia call intercepting server 236 only needs to perform image recognition if the identification information ascertained from the signaling information corresponds to the identifying information provided. If the identification information from the signaling information does not correspond to the identifying information provided, the call control entities 226 and 228 are configured to not forward the call to the voice/multimedia call intercepting server 236.

If the identifying information form the signaling information corresponds to the provided identifying information, the call control entities 226 and 228 request that the voice/multimedia call intercepting server 236 intercept the call. The voice/multimedia call intercepting server 236 thereafter intercepts the call in the manner described above, including comparing the image provided by the law enforcement agency 238 with the intercepted images. If there is a match, the/multimedia call intercepting server 236 duplicates, encapsulates, and transports the call content to the law enforcement agency 238.

If there is no match and one or more predetermined criteria are met, the voice/multimedia call intercepting server 236 may be configured to release the image recognition resources. The voice/multimedia call intercepting server 236 thereafter proceeds as described above, including notifying the call entity 226 or 228 accordingly that there is no match so that other steps may be taken.

An advantage of this approach is that both the identifying information and the image of the suspect can be confirmed. This is especially useful where the identifying information provided by the law enforcement agency 238 and the identifying information from the signaling information correspond, but the provided image and the intercepted images do not match. Such a scenario may occur, for example, where a multimedia device is used by many people and, as a result, identifying information such as the telephone numbers may match, but the images may not.

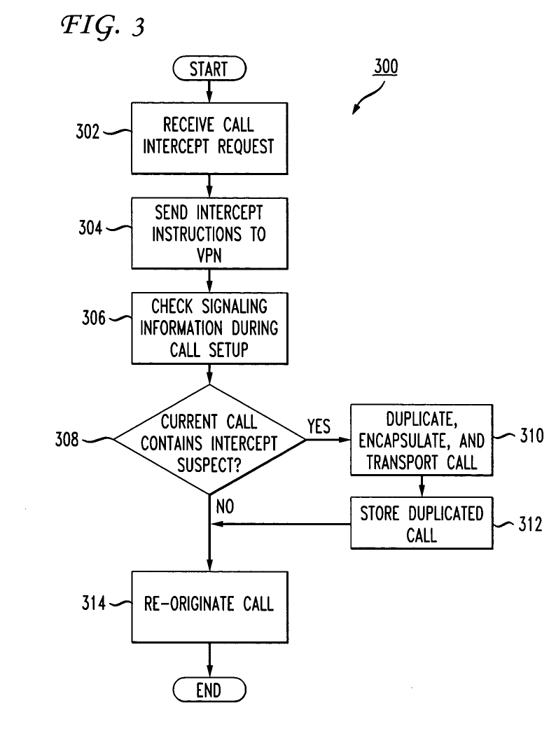

FIG. 3 illustrates a method 300 that summarizes in a general way the call intercepting procedure described above. As can be seen, the method 300 begins at step 302 wherein a law enforcement agency has submitted a request that the calls of a certain intercept subject be intercepted and monitored. Upon confirming the legal authorization for the call intercept, the administrator of the VPN sends instructions to the call control entity and the call intercepting server to carry out the interception at step 304. Thereafter, as each call is setup at step 306, a determination is made at step 308 as to whether the call contains the intercept subject. If the answer is yes, then at step 310 the call is duplicated, encapsulated, and transported to the law enforcement agency by the call intercepting server. The intercepted call is then stored in a database of the call intercepting server. If the current call does not contain the intercept subject, then the call is simply re-originated at step 314 and no duplication, encapsulation, or storage is performed on the call.

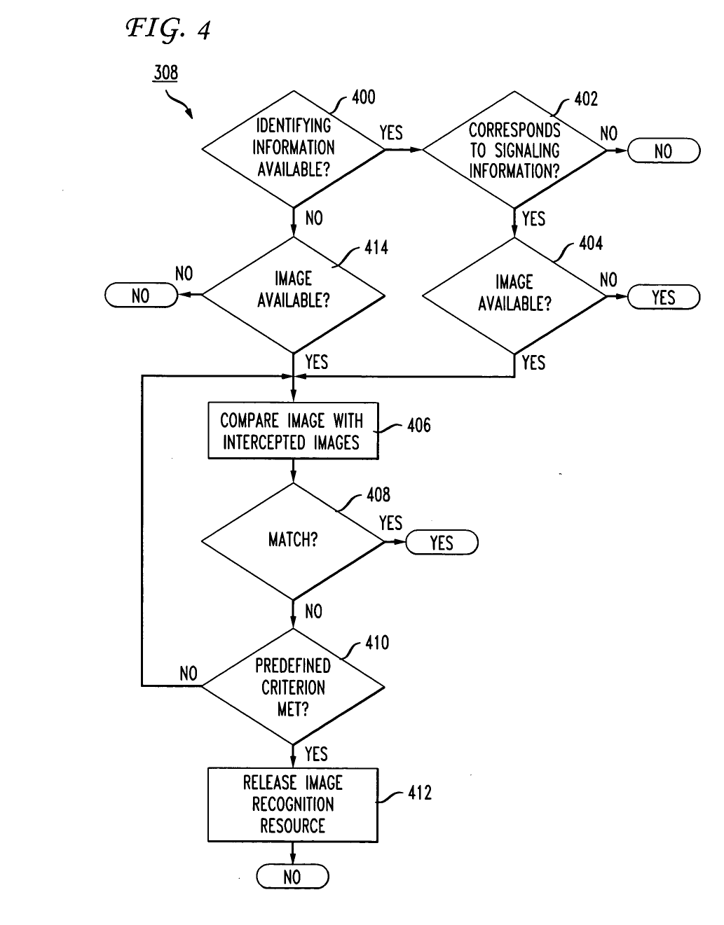

FIG. 4 illustrates the determination step 308 of FIG. 3 in more detail according to some embodiments of the invention. As can be seen, in some implementations, the determination step 308 begins by determining whether the law enforcement agency has provided any identifying information (e.g., telephone number, URL, name) for the intercept subject at step 400. If the answer is yes, then at step 402 a determination is made as to whether the identifying information corresponds to the identifying information from the signaling information of the current call. If it does not, then the determination step 308 follows the no branch in the method 300. If it does, then a determination is made at step 404 as to whether the law enforcement agency has provided an image for the intercept subject. If it has not, then it is assumed that the intercept subject is on the call, based on the correspondence between the identifying information provided and the signaling information, and the determination step 308 follows the yes branch. In that case, other means may need to be used to confirm the presence of the intercept subject on the call.

If the law enforcement agency has provided an image, then at step 406, a comparison of the provided image and the intercepted images is made using image recognition technology. At step 408, a determination is made as to whether there is a match for the images. If the answer is yes, then the intercept subject has been confirmed, and the determination step 308 follows the yes branch. If the answer is no, then the comparison continues until one or more predefined criteria are met at step 410. Thereafter, the image recognition resource is released, and the determination step 308 follows the no branch in the method 300.

If it turns out that the law enforcement agency has not provided any identifying information, but only an image of the intercept subject at step 414, then a comparison of the provided image and the intercepted images is performed at step 406 in the manner described above.

Referring back to FIG. 2, recall that the voice/multimedia call intercepting server 236 stores the voice/image/video content of the data packets in a database 240 after it has replicated and encapsulated the content. The signaling information as well as any identifying information for the intercept subject are also stored in the database 240. This database 240 is managed by the VPN administrator 234. In some embodiments, the VPN administrator 234 causes the call content, and any identifying information related to the intercept subject, to be stored in the database 240 in an encrypted state so that no unauthorized person can access the information (since only the law enforcement agency has the authority to see the information). Once the call content and identifying information are stored, it is important to be able to retrieve the call content and identifying information in a manner such that no information is lost. The is because, although the call content and identifying information are always sent to the law enforcement agency, if any information is lost during transmission, there must be a way to retrieve and retransmit that information. Thus, the database 240 that stores the call content and the signaling information of the intercept subject needs to always be properly maintained and in good working order.

In some embodiments, in addition to the identification information mentioned above (e.g., telephone number, URL, name), other identifying information may also be stored in the database 240. The other identifying information may include, for example, the network address of the intercept subject, such as the MAC address, IP address, VPN address, and the like. Thereafter, when the law enforcement agency 236 provides any of the above items of identifying information, that item of identifying information may be directly linked to other items of identifying information about the intercept subject.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. Method of intercepting a voice/multimedia communication in a virtual private network, the method comprising:
setting up the voice/multimedia communication in the virtual private network, the communication composed of a plurality of data packets and signaling information;
extracting an identifying information for the voice/multimedia communication from the signaling information;
determining whether at least one participant in the voice/multimedia communication matches an intercept subject;
duplicating the plurality of data packets and the signaling information if it is determined that there is a match; and
re-originating the plurality of data packets and the signaling information in the virtual private network.

2. The method according to claim 1, further comprising encapsulating the data packets and storing the data packets in a database if there is a match.

3. The method according to claim 1, further comprising transporting the duplicated data packets to a law enforcement agency if there is a match.

4. The method according to claim 1, wherein the step of determining includes comparing an image/picture from the voice/multimedia communication with an image/picture of the intercept subject.

5. The method according to claim 4, wherein the step of determining is performed only until one or more predefined criteria are satisfied if there is no match between the image/picture from the voice/multimedia communication and the image/picture of the intercept subject.

6. The method according to claim 1, wherein the step of determining is performed for substantially all voice/multimedia communications occurring in the virtual private network if only an image/picture of the intercept subject is available.

7. The method according to claim 1, wherein the step of determining is performed only when the identifying information extracted from the signaling information matches an identifying information for the intercept subject.

8. The method according to claim 9, further comprising collecting and storing the identifying information of the intercept subject if the step of determining results in a match.

9. A virtual private network capable of intercepting a voice/multimedia communication composed of a plurality of data packets and signaling information being routed therethrough, the virtual private network comprising:
a call control entity configured to set up the voice/multimedia communication in the virtual private network and to extract an identifying information from the signaling information; and
a call intercepting server configured to determine whether at least one participant in the voice/multimedia communication matches an intercept subject and to duplicate the plurality of data packets and the signaling information if there is a match; wherein the call control entity is further configured to re-originate the plurality of data packets and the signaling information in the virtual private network.

10. The virtual private network according to claim 9, wherein the voice/multimedia communication complies with one or more predefined signaling protocols, including a Voice Over IP (VoIP) protocol.

11. The virtual private network according to claim 9, wherein the signaling information complies with one or more predefined signaling protocols, including a Sessions Initiation Protocol (SIP) and a H.323 protocol.

12. The virtual private network according to claim 9, wherein format of the data packets complies with one or more predefined routing protocols, including a Real-time Transport Protocol (RTP).

13. The virtual private network according to claim 9, wherein the call intercepting server is a stand-alone server that is separate from the call control entity.

14. The virtual private network according to claim 9, wherein the call intercepting server is a functional feature within the call control entity.

15. The virtual private network according to claim 9, further comprising an access network including a plurality of access routers and a backbone network including a plurality of backbone routers, and the call control entity and the call intercepting server are connected to the access network and the backbone network.

16. The virtual private network according to claim 9, further comprising a virtual private network administrator configured to receive legal authorization for intercepting the/multimedia communication and to instruct the call control entity and the call intercepting server to carry out the interception.

17. The virtual private network according to claim 9, further comprising a database for storing the identifying information of the intercept subject if there is a match.

18. The virtual private network according to claim 9, wherein the call intercepting server determines if there is a match by comparing an image/picture from the voice/multimedia communication with an image/picture of the intercept subject.

19. The virtual private network according to claim 18, wherein the call intercepting server performs the determination only until one or more predefined criteria are satisfied if there is no match between the image/picture from the voice/multimedia communication and the image/picture of the intercept subject.

20. The virtual private network according to claim 9, wherein the call intercepting server performs the determination for substantially all voice/multimedia communications occurring in the virtual private network if only an image/picture of the intercept subject is available.

21. The virtual private network according to claim 9, wherein the call intercepting server performs the determination only when the identifying information extracted from the signaling information matches an identifying information for the intercept subject.
